(19) United States
(12) Patent Application Publication
(10) Pub. No.: US 2017/0318365 A1
(43) Pub. Date: Nov. 2, 2017

(54) CUSTOM SUBWOOFER POD

(71) Applicant: Kenneth Halstead, Deltona, FL (US)

(72) Inventor: Kenneth Halstead, Deltona, FL (US)

(21) Appl. No.: 15/428,336

(22) Filed: Feb. 9, 2017

Related U.S. Application Data
(60) Provisional application No. 62/293,382, filed on Feb. 10, 2016.

(51) Int. Cl. H04R 1/02

(52) U.S. Cl. CPC H04R 1/025; H04R 2499/13

(57) ABSTRACT

A subwoofer pod for housing an audio subwoofer, the subwoofer pod adapted to be installed in a vehicle having a rear storage compartment. The subwoofer pod comprising an enclosure that includes a top plate having an opening for mounting the audio subwoofer therein, and a front plate adapted to face a front of the vehicle including mounting tabs having mounting holes for mounting with the rear storage compartment.

### CROSS REFERENCE TO RELATED APPLICATION

This application claims the priority of U.S. Provisional Application No. 62/293,382, entitled “CUSTOM SUBWOOFER POD,” filed on Feb. 10, 2016, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to subwoofer pods, and in particular, specially configured subwoofer pods designed to fit in compact storage compartments.

### Description of the Related Art

Creating a quality audio system requires more than just good sound equipment. In order to create a well-balanced sound stage, speakers and subwoofers need proper placement, which is not always an easy task in tight spaces such as in performance vehicles. Speaker pods allow adding speakers to a door location to create a custom sound configuration. It is known to install speaker pods on doors or in small corners such as on the floor and sidewall along the door, such as described in U.S. Pat. No. 6,614,913. Such a design provides for mounting speaker pods on the left and right sides in the vehicle cabin.

Subwoofers are usually larger than speakers and require substantially more installation space. Often times, subwoofers are usually placed in the trunk or in the cabin of larger vehicles such as roomy sports utility vehicles, pickup trucks, and minivans. Owners of smaller vehicles may have to take a pass at installing a subwoofer in the vehicle's cabin. Installation of subwoofers is only feasible in vehicles with ample trunk space or larger vehicles where there is plenty of leg and seating room.

None of the prior solutions are able to provide a stereo setup in vehicles with limited cabin and cargo space. There is thus a need in the industry to provide subwoofer pods tailored to fit in smaller storage compartments of vehicles such as in performance vehicles.

### SUMMARY OF THE INVENTION

The present invention provides a subwoofer pod for housing an audio subwoofer. The subwoofer pod adapted to be installed in a vehicle having a rear storage compartment. The subwoofer pod comprising an enclosure that includes a top plate having an opening for mounting a subwoofer therein, and a front plate adapted to face a front of the vehicle including mounting tabs having mounting holes for mounting with the rear storage compartment.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a view of the front and top sides of a subwoofer pod according to an embodiment of the present invention;

FIG. 2 illustrates a view of the right and top sides of the subwoofer pod according to an embodiment of the present invention; and

FIG. 3 illustrates an exemplary placement of the subwoofer pod according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention Likewise, a reasonably broad scope for claimed or covered subject matter is intended. The following detailed description is, therefore, not intended to be taken in a limiting sense.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

Embodiments of the present invention provide subwoofer pods for installation in a compact storage compartment such as in a Polaris Slingshot three-wheeled motorcycle. The subwoofer pods may fit in storage compartments behind the driver and passenger seats and house a subwoofer up to 10″ in diameter that fires upwards to the top of the storage compartments to produce a deeper bass note than conventional enclosures where the subwoofer faces the back of the seats. The pods are constructed of fiberglass and medium-density fiberboard (MDF) or any other material known in the art, and may be molded directly from the storage compartments for a perfect fit.

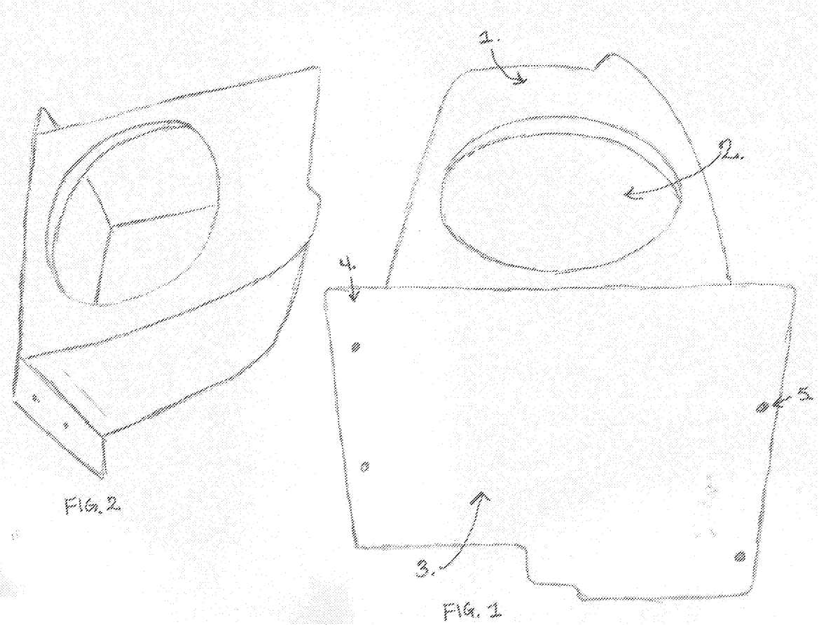

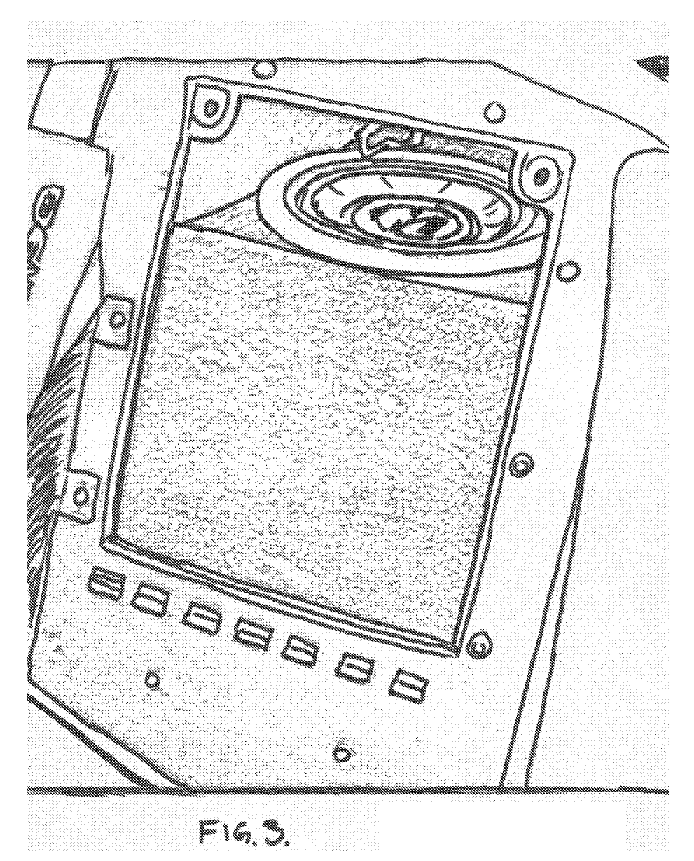

FIG. 1 presents a view of the front and top sides of an exemplary subwoofer pod according to an embodiment of the present invention. The subwoofer pod may be installed in a seat storage compartment in a rear area of a vehicle (e.g., behind the driver's side). The subwoofer pod includes a top plate 1 that may be made from ⅝″ MDF. Top plate 1 includes cut out 2 for mounting of a subwoofer device. The subwoofer pod further includes a front plate 3 when configured in the seat storage compartment faces the seat of the vehicle. Front plate 3 includes mounting tabs 4 on left and right sides of the subwoofer pod. The mounting tabs 4 include mounting holes 5 capable of accepting screws or bolts for installation in the seat storage compartment. FIG. 2 provides an additional view of the subwoofer pod illustrating the right and top sides of the subwoofer pod according to an embodiment of the present invention.

FIG. 3 presents an exemplary placement of the subwoofer pod in a seat storage compartment according to an embodiment of the present invention. The subwoofer pod may fit in the storage compartments behind the driver and passenger seats. Cut out 2 facilitates mounting a subwoofer device in the subwoofer pod such that it (e.g., the subwoofer driver) fires upwards to the top of the storage compartment to produce a deeper bass note as opposed to front-firing the subwoofer towards the back of the seats.

FIGS. 1 through 3 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A subwoofer pod for housing an audio subwoofer, the subwoofer pod adapted to be installed in a vehicle having a rear storage compartment, the subwoofer pod comprising an enclosure that includes:
a top plate having an opening for mounting the audio subwoofer therein,
a front plate adapted to face a front of the vehicle including mounting tabs having mounting holes for mounting with the rear storage compartment.
